(19) United States
(12) Patent Application Publication
(10) Pub. No.: US 2018/0022193 A1
(43) Pub. Date: Jan. 25, 2018

(54) AIR REGISTER ASSEMBLIES IN A VEHICLE AND METHODS TO ASSEMBLE THE SAME

(71) Applicant: Ford Global Technologies, LLC, Dearborn, MI (US)

(72) Inventors: Ryan Lin, Nanjing (CN); Jude D'Souza, Beaumaris (AU); Matt Zhou, Nanjing (CN); Evan Tian, Nanjing (CN)

(21) Appl. No.: 15/634,988

(22) Filed: Jun. 27, 2017

(30) Foreign Application Priority Data
Jul. 20, 2016 (CN) 20161057368.3

(51) Int. Cl. B60H 1/34; B23P 19/04

(52) U.S. Cl. CPC B60H 1/3421; B23P 19/04

(57) ABSTRACT

An air register assembly is provided. The air register assembly includes a housing having an open end, a flange disposed at the open end of the housing, a pair of retainers connecting a plurality of vanes in the housing. The retainers are positioned on external sides of opposite side walls of the housing and adjacent to the flange. The vanes are disposed in the housing and rotatably connected to the retainers.

### RELATED APPLICATION

This application claims the benefit of Chinese Patent Application No.: CN 201610577368.3 filed on Jul. 20, 2016, the entire contents thereof being incorporated herein by reference.

### FIELD

The present disclosure relates to air conditioning apparatus, more particularly to an air register assembly and a method of assembling the air register assembly.

### BACKGROUND

An air register assembly is an interior part of a vehicle. Generally, it is disposed at a dashboard, a roof trim, and/or a center console of the vehicle. After the compartment temperature of the vehicle is set by a user and the air is conditioned, cooled or heated air can flow into the vehicle compartment via the air register to improve comfortability for the passengers. A conventional air register assembly may include a bezel or a decoration panel connected to a housing for covering retainers connected within the housing or appearance of lubricating oils for vanes if there is any. Generally, the bezel is connected to the housing via screws or clips. For example, Chinese patent application No. CN201488215U discloses a connection structure to connect a casing of air conditioner air outlet and a bezel in a vehicle. The connection structure includes the casing and the bezel arranged on the outer periphery of an end of the casing, a connecting arm extends from the bezel and has a connecting hole at the front end thereof, a connecting hole is arranged at a front-end portion of the connecting arm. Correspondingly a connecting block is disposed at the external side of a side wall of the casing for clipping or connecting with the connecting hole. In addition, the casing includes a pair of clipping paws connected on the external side of the side wall and positioned close to the connecting block for restraining swing motion of the connecting arm at lateral sides.

Inventors of the present application have recognized that the conventional air register assemblies have some problems. For example, the retainers for the vanes are disposed in the housing and the bezel is fixed to the housing via screws or clips. Such structure requires holes formed on the housing for receiving connecting bolts or clips, and the retainers for the vanes can be seen through the gaps between the vanes. Further, the manufacturing cost can be higher due to multiple parts, complicated structure and difficulty to assemble.

### SUMMARY

The present disclosure provides an air register assembly to at least address some of the issues described above. The air register assembly has a simple structure which results in better stability and aesthetic appearance. Further, the air register assembly is easy to be assembled, low in manufacturing cost, and convenient for maintenance and replacement.

According to one aspect of the present disclosure, an air register assembly is provided. The air register assembly includes a housing, a flange, a pair of retainers, and a plurality of vanes. The housing has an open end, and the flange is disposed at the open end of the housing. The retainers are disposed at external sides of opposite side walls of the housing and adjacent to the flange. The plurality of vanes are disposed in the housing and rotatably connected to the retainers.

In some embodiments, the housing and the flange are integrally formed.

In some embodiments, the flange has a width larger than a thickness of the retainer.

In some embodiments, each of the vanes has two recesses at two opposite ends, respectively. Each of the retainers has a plurality of protrusions corresponding to the recesses at ends of the vanes. The side walls of the housing has a plurality of through holes corresponding to the plurality of vanes. The protrusions of the retainers extend through the through holes in the side walls to be received in the recesses at ends of the vanes so that the vanes are rotatably connected to the retainer.

According to another aspect of the present disclosure, an air register assembly is provided. The air register assembly includes a housing, a flange, a pair of first retainers, and a first vane set. The housing has a first open end and a second open end opposite to the first end, and the first open end is in communication with an air outlet pipe of an air conditioning system. The flange is connected to an external peripheral of the second open end. The first retainers are connected to external sides of two opposite longitudinal side walls adjacent to the second open end. The first vane set includes a plurality of first vanes, each of the first vanes are disposed in the second open end and rotatably connected to the first retainers.

In some embodiments, the flange and the housing are integrally formed. In some embodiments, the flange is connected to the second open end via screw, rivet, clip, adhesive, or combinations thereof.

In some embodiments, each of the first retainers is connected to the second open end via screw, rivet, clip, adhesive, or combinations thereof.

In some embodiments, each of the first vanes has a lateral length smaller than that of the second open end, a distance between a lateral end of each of the first vanes and an internal side of the longitudinal side wall of the second open end is in a range of about 0.5 mm to about 5 mm.

In some embodiments, each of the first retainers has a plurality of protrusions corresponding to the first vane set, and two ends of each of the first vanes have recesses for receiving the protrusions of the first retainers. The protrusions of the first retainers extend through a plurality of through holes in each of the longitudinal side wall of the second open end to be received in the recesses of the first vanes such that each of the first vanes is rotatable around the protrusion of the first retainers.

In some embodiments, the first vane set has a driving vane and a plurality of driven vanes, and the driven vanes are driven by the driving vane via a linkage mechanism.

In some embodiments, the first vane set further includes an air adjusting member connected to the driving vane.

In some embodiments, the first vane set further includes a pair of second retainers and a second vane set. The second retainers are connected to external sides of opposite lateral side walls of the second open end. The second vane set is positioned substantially perpendicular to the first vane set and disposed at a position closer to the first open end relative to the first vane set in the housing. The second vane set includes a plurality of second vanes each rotatably connected to the second retainers.

In some embodiments, each of the second retainers has a plurality of protrusions corresponding to a number of vanes of the second vane set, and each of the second vanes has two recesses at two opposite ends thereof for receiving the protrusions of the second retainers. The protrusions of each of the second retainers extend passing through-holes in one lateral side wall adjacent to the second open end to be received in the recesses at one end of the second vanes, such that each of the second vanes is rotatable relative to the second retainers.

In some embodiments, the flange has a width larger than a thickness of the first or second retainers.

According to one aspect of the present disclosure, a method for assembling an air register assembly is provided. The method includes positioning a plurality of vanes; arranging a housing with an open end around the vanes such that the vanes is enclosed in the open end of the housing; connecting a pair of retainers to external sides of opposite side walls of the housing; and connecting each of the vanes to the retainers via a plurality of through-holes in each of the side walls so that each of the vanes is rotatably connected to the retainers.

In some embodiments, each of the vanes has two recesses at two opposite ends thereof, each of the retainers has a plurality of protrusions corresponding to the vanes. Connecting each of the vanes to the retainers includes arranging the retainers such that protrusions of each of the retainers extend through the through-holes in the side walls of the housing to be received in the recesses at one end of the vanes.

In some embodiments, connecting a pair of retainers to external sides of opposite side walls of the housing and connecting each of the vanes to the retainers are performed substantially at the same time.

In some embodiments, the air register assembly further includes a flange disposed at the open end of the housing.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

The above advantages and other advantages, and features of the present description will be readily apparent from the following detailed description when taken alone or in connection with the accompanying drawings.

### BRIEF DESCRIPTION OF THE DRAWINGS

FIG. 1 is a perspective exploded view of an air register assembly according to an embodiment of the present disclosure, illustrating various parts of the air register assembly.

FIG. 2 is a perspective view of an air register assembly according to another embodiment of the present disclosure, illustrating the air register assembly at an assembled position.

FIG. 3 is an enlarged cross-sectional view of the air register assembly of FIG. 2 along line A-A, illustrating the connection between the vanes, housing, and the retainers.

FIG. 4 is a flow chart of a method of assembling an air register assembly according to an embodiment of the present disclosure.

### DETAILED DESCRIPTION OF ONE OR MORE EMBODIMENTS

Embodiments of the present disclosure are described herein. It is to be understood, however, that the disclosed embodiments are merely examples and other alternative embodiments can take various forms. The figures are not necessarily to be drawn in scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

An air register assembly in a vehicle is a part of an air conditioning system for improving comfortability of the passengers. Generally, the air register assembly should not only satisfy the requirements of air flow or air discharge direction, but also need to have desired stability good and aesthetic appearance.

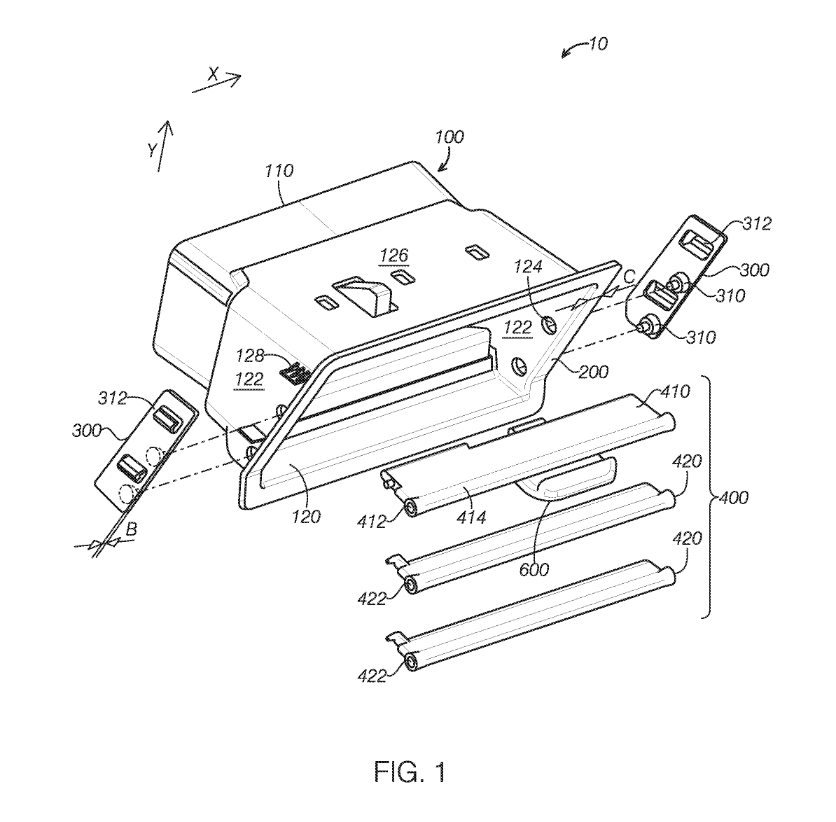

FIG. 1 is a perspective exploded view of an air register assembly 10 according to an embodiment of the present disclosure, illustrating various parts of the disassembled air register assembly. As shown in FIG. 1, the air register assembly 10 includes a housing 100, a flange 200, a pair of retainers 300, and a plurality of vanes 400. The housing 100 has an open end, for example, a first open end 110 and a second open end 120 opposite to the first open end 110. The first open end 110 may be in communication with an air outlet duct of an air conditioning system of a vehicle (not shown). In other words, with respect to an air flow direction of the air conditioning system of a vehicle, the first open end is located upstream of the second open end 120.

The flange 200 is disposed or connected at an open end of the housing 100 For example, the flange 200 may be disposed at or connected to the housing 100 at the peripheral of the second open end 120. In some embodiments, the housing 100 and the flange 200 may be integrally formed. In other words, the housing 100 and the flange 200 may be formed as an integral part in one mold. In some embodiments, the flanged 200 may be connected or coupled to the housing 100 at the second open end 120 via screw, rivet, clip, adhesives, or combinations thereof.

The retainers 300 may be connected to external side of opposite side walls of the housing respectively and positioned close to the flange 200. Referring to FIG. 1, the air register assembly 10 includes a pair of first retainers 300. The first retainers 300 may be detachably connected to external sides of the opposite longitudinal side walls 122 (e.g. side walls along direction Y) of the second open end 120 of the housing 100. In some embodiments, the first retainers 300 may be connected to the external sides of the side walls 122 of the housing 100 via screw, rivet, clip, adhesive, or combinations thereof.

In some embodiments, as shown in FIG. 1, the housing 100 has a first clip 128 disposed at or connected to the external side of the side wall 122, while each of the first retainers 300 has a second clip 312. The first clip 128 and the second clip 312 may cooperate with each other to connect or fix the first retainers 300 to the external sides of the side wall 122 of the housing 100, respectively. Although the air register assembly 10 shown in FIG. 1 has two first clips 128 and two second clips 312, there is no limit to the numbers of the first and second clips, provided cooperation thereof ensures that the first retainers 300 can be fixed or connected to the external sides of the side walls 122 of the housing 100.

It should be appreciated that the connection between the flange 200 and the housing 100 as well as the connection between the first retainers 300 and the housing 100 should not be limited to those described above, such as screw, rivet, clip, adhesive, or combinations thereof. Those with ordinary skill in the art may properly select additional or alternative connections as appropriate and should also be considered within the scope of the present disclosure.

In some embodiments, each of the first retainers 300 has a thickness B no larger than a width C of the flange 200 in a direction X. In other words, the width C of the flange 200 may be larger than the thickness B of the retainer 300 in the direction X. In this way, the flange 200 may block the first retainers 300 from the view of the passengers or the users. In addition, as the first retainers 300 are outside of the housing 100, the first retainers 300 may not be visible from gaps between vanes of the air register assembly 10, and thus provides better aesthetic appearance.

The vanes 400 may be disposed in the housing 100 and rotatably connected to the first retainers 300. As shown in FIG. 1, the air register assembly 10 includes a first vane set 400. The first vane set 400 includes a plurality of first vanes. In some embodiments, each of the first vanes may be rotatable relative to the first retainers 300. In some embodiments, as shown in FIG. 1, the first vane set 400 includes a driving vane 410 and a plurality of driven vanes 420. Each of the driving vane 410 and the driven vanes 420 may be rotatably connected to the first retainers 300 in the second open end 120 of the housing 100.

In some embodiments, the air register assembly 10 further includes a linkage mechanism (not shown) connecting the driving vane 410 to the driven vanes 420. Each of the driving vane 410 and the driven vanes 420 is connected with the linkage mechanism, such that the driven vanes 420 may be driven by the driving vane 410 via the linkage mechanism. The linkage mechanism may be known in the art and the technician and the linkage mechanism would not be described herein.

In some embodiments, each of the driving vane 410 and the driving vanes 420 are rotatably connected to the first retainers 300 via protrusion-recess structure.

In some embodiments, as shown in FIG. 1, each of the first retainers 300 may include a plurality of protrusions 310 corresponding to the first vane set 400. The driving vane 410 has two recesses 412 at two opposite ends thereof for receiving corresponding protrusions 310 of the first retainers 300. Similarly, each of the driven vanes 420 has two recesses 422 at two opposite ends thereof for receiving corresponding protrusions 310 of the first retainers 300. The protrusions 310 of each of the first retainers 300 may extend through a plurality of through holes 124 in the side wall 122 of the second open end 120 to receive in the recess 412 at one end of the driving vane 410 and the recesses 422 at one end of the driven vanes 420. In this way, each of the driving vane 410 and the driven vanes 420 may be rotatable relative to the protrusions 310 of the first retainers 300.

In some embodiments, as shown in FIG. 1, one of the first retainers 300 at the right of the housing 100 has two protrusions 310, the right side wall 122 has two through holes 124 therein, the driving vane has a recess 412 at the right end thereof, and the driven vane 420 has a recess 422 at the right end thereof. The two protrusions 310 at the right one of the first retainers 300 may extend through the two through holes 124 in the right side wall 122 of the housing to receive in the recess 412 at the right end of the driving vane 410 and the recess 422 at the right end of the driven vane 420. Similarly, the two protrusions 310 of the first retainer 300 at the left side may extend through the two through holes 124 in the left side wall 122 of the housing to be received in the recess 412 at the left end of the driving vane 410 and the recess 422 at the left end of the driven vane 420. In this way, the driving vane 410 and the driven vane 420 may be rotatable about corresponding protrusion 310 of the first retainers 300 in the second open end 120 of the housing 100.

It should be appreciated that, the air register assembly 10 may include more driven vanes 420, not limited to two driven vanes 420 as shown in FIG. 1. The number of protrusions 310 of each of the first retainers 300, the number of first vanes of the first vane set 400 (i.e. the total number of driving vane 410 and the driven vanes 420) are not limited to three as shown in FIG. 1.

Although in the above described embodiments, the first vane set 400 includes recesses while the first retainers 300 include protrusions, and the first vane set 400 is rotatable relative to the first retainers 300 in the housing 100, the present disclosure is not limited to such configuration. In alternative embodiments, each of the vanes in the first vane set 400 (e.g. the driving vane 410 and/or the driven vanes 420) may have two protrusions at the opposite ends, each of the first retainers 300 may have recesses in each of the protrusions 310 thereof, the protrusions of the first retainers 300 extend through holes 124 in the side wall 122 of the housing 100 and the protrusions at two ends of the vanes of the first vane set 400 are received in the recesses of the protrusions 310 of the first retainers 300, such that each vane of the first vane set 400 is rotatable relative to the first retainers 300 in the housing 100.

In some embodiments, the air register assembly may further include an air adjusting member 600. As shown in FIG. 1, the air adjusting member 600 may be connected on the external side of the driving vane 410. The air adjusting member 600 may adjust an angle of the driving vane 410, which moves the linkage mechanism to change the position of the driven vanes 420 such that air flow, air flow direction, may be adjusted.

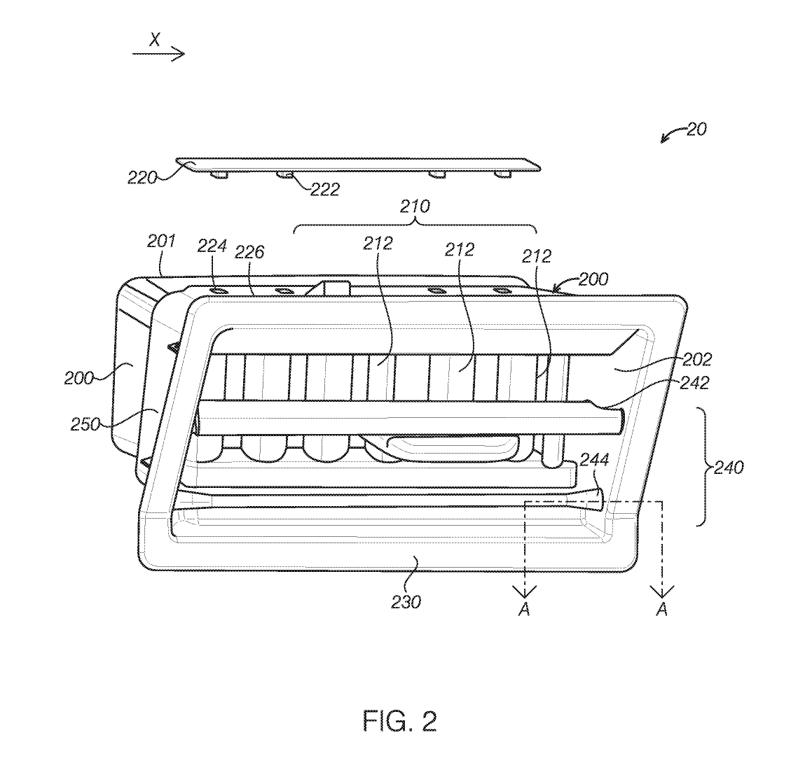

FIG. 2 is a perspective view of an air register assembly 20 according to an embodiment of the present disclosure, illustrating an air register assembly at an assembled position. In some embodiments, as shown in FIG. 2, the air register assembly 20 includes a first vane set 240 having a plurality of first vanes 242, 244, a pair of first retainers 250, a second vane set 210, and a pair of second retainers 220. FIG. 2 illustratively shows one of the second retainers 220.

The second retainers 220 are detachably connected to external side of opposite lateral side walls 226 (i.e., side wall along direction X) of the second open end 202 of the housing 200. The second vane set 210 in the second open end 202 of the housing is closer to the first open end 201 relative to the first vane set 240, and is substantially vertically oriented relative to the first vane set 240. The second vane set 210 has a plurality of second vanes 212 each rotatably connected to the second retainers 220. The orientation of the first vane set 240 relative to the housing 200, the structure of the first vane set 240, the connection between the first vane set 240 and the housing 200, the rotation cooperation between the first vane set 240 and the first retainers 220, and various other parts of the air register assembly 20 (e.g., recesses or protrusions) may refer to those described above with reference to the first vane set 400 as shown in FIG. 1.

In some embodiments, each of the second retainers 220 may have a plurality of protrusions 222 corresponding to the second vane set 210. Each of the second vanes 212 may have two recesses (not shown) at two opposite ends thereof for receiving corresponding protrusions of the second retainers 220. The protrusions of each of the second retainers 220 extend through a plurality of through holes 224 formed in each of lateral side wall 226 of the housing 200 to reside in recesses of the second vanes 212, such that each of the second vanes 212 is rotatable about the protrusions of the second retainers 220.

It should be appreciated that, in addition to the orientation of the second retainers 220 to the housing 200, the structure of the second retainers 220, the connection between the second retainers 220 and the housing 200, the cooperation between the second retainers 220 and the second vane set 210, and various other members (e.g., protrusions or recesses) of the second air register assembly 20 may refer to those described above with reference to the first retainers 300. Further, in addition to the orientation of the second vane set 210 to the housing 200, the structure of the second vane set 210, the connection between the second vane set 210 and the housing 200, the rotation cooperation between the second vane set 210 and the second retainers 220, and various other parts (such as protrusions or recesses) of the second air register assembly 20 may refer to those described above with reference to the first vane set 400 shown in FIG. 1. For the sake of brevity, the relevant details are not described herein. It should be appreciated that, the second vane set 210 may have different shape, length, or number from the first vane set 240, and the second retainers 220 may have different shape, length, or number from the first retainers 250. Those with ordinary skill in the art may properly select the shape, length, or number of the first and second vane sets 210, 220 and the first and second retainers 250, 220 according to practical requirements, which should be considered to be included in the scope of the present disclosure.

In some embodiments, in the direction Y, the flange 230 may have a width larger than a thickness of the second retainers 220. In this way, the retainers 220 may be blocked by the flange 230 from view of the passengers. In addition, the second retainers 220 are disposed at or connected to the external side of the housing 200, and thus the second retainers 220 may not be seen from the gaps between vanes of the air register assembly. Thus, the air register assembly 20 may have better appearance.

In some embodiments, the second vane set 210 may be rotatably connected in the housing 100 (not shown) via conventional means. For example, two second retainers 220 may be connected to internal sides of the opposite side walls of the first open end 201, each of the vanes of the second vane set 210 may be rotatably connected to the second retainers 220, thus each of the vanes of the second vane set 210 may rotate or be driven to rotate in the housing 200. In such embodiments, the second retainers 220 may be connected to the interior of the housing 200 via any conventional means, such as screw, rivet, clip, adhesive, or combinations thereof.

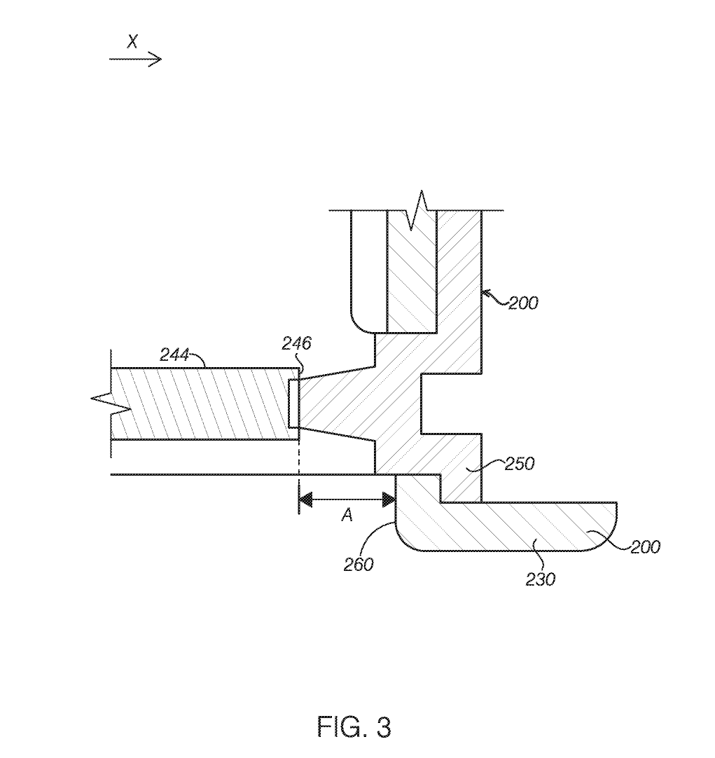

FIG. 3 is an enlarged partial cross-sectional view of the air register assembly in FIG. 2 along line A-A. In some embodiments, each of the driving vane 242 and the driven vanes 244 may have a length smaller than the width of the second open end 202 of the housing 200 in direction X. FIG. 3 illustrates a distance A between an end 246 of the driven vane 244 and an internal wall 260 of the housing 200. The distance A may be in a range of about 0.5 mm to about 5 mm, preferably in a range of about 1 mm to about 4 mm, or alternatively in a range of about 2 mm to about 3 mm. FIG. 3 further illustrates the first retainers 250, the flange 230, and the housing 200.

In some embodiments, the first driving vane 242 and the first driven vanes 244 may be rotatably connected to the first retainers 250 via a protrusion-recess structure. Similarly, the vanes of the second vane set 210 may be rotatably connected to the second retainers 220 via a protrusion-recess structure.

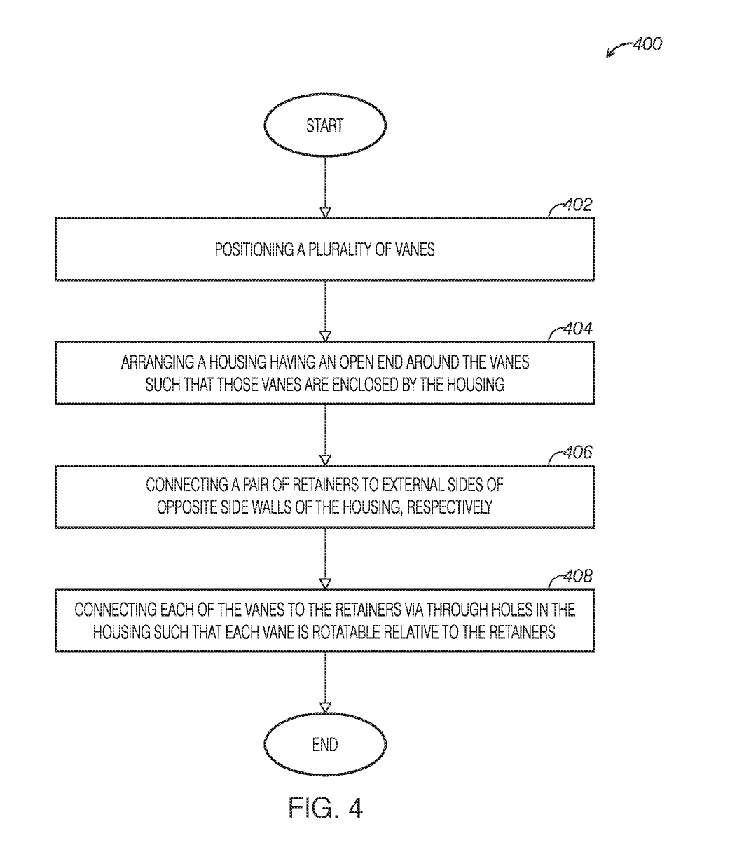

Another aspect of embodiment of the present disclosure provides a method 400 of assembling an air register assembly. Referring to FIG. 4, a flow chart is shown to illustrate a method 400 for assembling an air register assembly. At step 402, the method 400 may include positioning a plurality of vanes. Positioning the plurality of vanes may include arranging the plurality of vanes in a predetermined position at a platform. The plurality of vanes may include a first vane set and a second vane set. In some embodiments, the method 400 may include placing the connected first and second vane sets in the predetermined position at the platform. At step 404, the method 400 may include arranging a housing having an open end around the first and second vane sets such that the vanes are enclosed by the housing. In other words, the vanes are received in the open end of the housing in the step 404. In step 406, the method 400 may include connecting a pair of retainers to external sides of opposite side walls of the housing, respectively. At step 408, the method 400 may include connecting each of the vanes to the retainers via through holes in the housing such that each vane is rotatable relative to the retainers. For example, each of the retainers may have connecting parts (e.g., protrusions) which may extend or pass through holes in side walls of the housing to be connected with corresponding connecting parts (e.g., recesses) at two ends of each vane. In this way, each vane is rotatable relative to the retainers.

In some embodiments, the retainers may be connected to the external sides of the housing via screw, rivet, clip, adhesive, or combinations thereof.

In some embodiments, each vane may have two recesses at two opposite ends, respectively each of the retainers may have a plurality of protrusions corresponding to the recesses of the vanes. At the step 408, the method 400 may include extending the protrusions of each of the retainers through holes in side walls of the housing to be received in the recesses of the vanes. It should be appreciated that connecting the vanes and the retainers at step 406 may be performed with connecting the retainers to the external sides of the housing at step 408. In other words, the steps 406 and 408 may be performed substantially at the same time.

In some embodiments, the air register assembly further includes a second vane set oriented substantially vertical to the first vane set. The second vane set is disposed closer to the first open end of the housing which is in communication with an air outlet duct of an air conditioning system of a vehicle. In some embodiments, the steps 406, 408 each further includes the step of mounting the second vane set.

In some embodiments, the air register assembly further includes a flange connected to or disposed at the peripheral of the second open end of the housing. In some embodiments, the flange is integrally formed with the housing. In some embodiments, the method further includes a step of connecting the flange at the second open end of the housing.

In some embodiments of the present disclosure, the retainers (such as the first retainers 300 or the second retainers 220) may be disposed at or connected to the external sides of the housing 100 (or housing 200) and the vanes (such as the first vane set 400 and/or the second vane set 210) are rotatably connected to the retainers in the housing 100 (or housing 200). The flange is formed integral with the housing and block the connection between the retainer and the housing side wall from the view of the users, which may simplify the manufacturing process and provide a better aesthetic appearance. In addition, the air register assembly according to embodiments of the present disclosure not only has aesthetic appearance, simple structure, low manufacturing cost, and reliable stability, but also is convenient to assemble, disassemble, maintain, and replace.

The air register assembly of the present disclosure may be used in a passenger vehicle, a commercial vehicle, or various other vehicles, such as agriculture machines, transportation ships, or airplanes. Those applications should be considered as included in the scope of term “vehicle” cited in this disclosure.

It should be appreciated that the embodiments described above are specific examples that do not encompass all possible forms of the disclosure. The features of the illustrated embodiments may be combined to form additional or alternative embodiments of the disclosed concepts. The words used in the specification are words of description rather than limitation, and it is understood that changes can be made without departing from the spirit and scope of the disclosure. The scope of the following claims is broader than the specifically disclosed embodiments and includes modifications of the illustrated embodiments.

1. An air register assembly comprising:
a housing having an open end;
a flange disposed at the open end of the housing;
a pair of retainers disposed at external sides of opposite side walls of the housing and adjacent to the flange; and
a plurality of vanes disposed in the housing and rotatably connected to the retainers.

2. The air register assembly of claim 1, wherein the housing and the flange are integrally formed.

3. The air register assembly of claim 1, wherein the flange has a width larger than a thickness of the retainer.

4. The air register assembly of claim 1, wherein each of the vanes has two recesses at two opposite ends, respectively, each of the retainers has a plurality of protrusions corresponding to the recesses at the ends of the vanes, and the side walls of the housing has a plurality of through holes corresponding to the plurality of vanes; wherein the protrusions of the retainers extend through the through holes in the side walls to be received in the recesses at the ends of the vanes so that the vanes are rotatably connected to the retainer.

5. An air register assembly comprising:
a housing having a first open end and a second open end opposite to the first end, the first open end in communication with an air outlet pipe of an air conditioning system;
a flange connected to an external peripheral of the second open end;
a pair of first retainers connected to external sides of two opposite longitudinal side walls adjacent to the second open end; and
a first vane set including a plurality of first vanes, each of the first vanes being disposed in the second open end and rotatably connected to the first retainers.

6. The air register assembly of claim 5, wherein the flange and the housing are integrally formed.

7. The air register assembly of claim 5, wherein the flange is connected to the second open end via screw, rivet, clip, adhesive, or combinations thereof.

8. The air register assembly of claim 5, wherein each of the first retainers is connected to the second open end via screw, rivet, clip, adhesive, or combinations thereof.

9. The air register assembly of claim 5, wherein each of the first vanes has a lateral length smaller than that of the second open end, a distance between a lateral end of each of the first vanes and an internal side of the longitudinal side wall of the second open end is in a range of about 0.5 mm to about 5 mm.

10. The air register assembly of claim 9, wherein each of the first retainers has a plurality of protrusions corresponding to the first vane set, and two ends of each of the first vanes have recesses for receiving the protrusions of the first retainers; and wherein the protrusions of the first retainers extend through a plurality of through holes in each of the longitudinal side wall of the second open end to be received in the recesses of the first vanes such that each of the first vanes is rotatable around the protrusion of the first retainers.

11. The air register assembly of claim 5, wherein the first vane set has a driving vane and a plurality of driven vanes, and the driven vanes are driven by the driving vane via a linkage mechanism.

12. The air register assembly of claim 11, further comprising an air adjusting member connected to the driving vane.

13. The air register assembly of claim 5, further comprising:
a pair of second retainers connected to external sides of opposite lateral side walls of the second open end; and
a second vane set positioned substantially perpendicular to the first vane set and disposed at a position closer to the first open end relative to the first vane set, wherein the second vane set includes a plurality of second vanes each rotatably connected to the second retainers.

14. The air register assembly of claim 13, wherein each of the second retainers has a plurality of protrusions corresponding to a number of vane of the second vane set, each of the second vanes has two recesses at two opposite ends thereof for receiving the protrusions of the second retainers; wherein the protrusions of each of the second retainers extend passing through holes in one lateral side wall adjacent to the second open end to be received in the recesses at one end of the second vanes, such that each of the second vanes is rotatable relative to the second retainers.

15. The air register assembly of claim 13, wherein the flange has a width larger than a thickness of the first or second retainers.

16. A method for assembling an air register assembly comprising:
positioning a plurality of vanes;
arranging a housing with an open end around the vanes such that the vanes is enclosed in the open end of the housing;
connecting a pair of retainers to external sides of opposite side walls of the housing; and
connecting each of the vanes to the retainers via a plurality of through holes in each of the side walls so that each of the vanes is rotatably connected to the retainers.

17. The method of claim 16, wherein connecting a pair of retainers to external sides of opposite side walls of the housing includes connecting the retainers to the housing via screw, rivet, clip, adhesive, or combinations thereof.

18. The method of claim 16, wherein each of the vanes has two recesses at two opposite ends thereof, and each of the retainers has a plurality of protrusions corresponding to the vanes; and wherein connecting each of the vanes to the retainers includes arranging the retainers such that protrusions of each of the retainers extend through the through holes in the side walls of the housing to be received in the recesses at one end of the vanes.

19. The method of claim 16, wherein connecting a pair of retainers to external sides of opposite side walls of the housing and connecting each of the vanes to the retainers are performed substantially at the same time.

20. The method of claim 16, wherein the air register assembly further includes a flange disposed at the open end of the housing.
